(19) United States
(12) Patent Application Publication
(10) Pub. No.: US 2026/0369051 A1
(43) Pub. Date: Nov. 19, 2026

(54) IMAGE PROCESSING DEVICE AND IMAGE PROCESSING METHOD

(71) Applicant: NEC Corporation, Tokyo (JP)

(72) Inventor: Yoshikazu WATANABE, Tokyo (JP)

(73) Assignee: NEC Corporation, Tokyo (JP)

(21) Appl. No.: 19/486,984

(22) PCT Filed: May 29, 2023
(86) PCT No.: PCT/JP2023/019962

§ 371 Date: Nov. 24, 2025

(51) Int. Cl. G06V 10/96; G06V 10/764; G06V 10/776

(52) U.S. Cl. CPC G06V 10/96; G06V 10/764; G06V 10/776

(57) ABSTRACT

The inference means 72 performs predetermined inference on sequentially input images, and increases processing efficiency of inference by simplifying processing for a predetermined portion of images when performing the predetermined inference. The ground truth data generation means 74 generates, for some of the input images, ground truth data including an image and a ground truth label that is a ground truth corresponding to the predetermined inference for the image. The computational resources allocation means 73 allocates unused computational resources to the inference means 72, and when surplus computational resources which are unused computational resources remaining from allocated computational resources occur in the inference means 72, allocates the surplus computational resources to the ground truth data generation means 74.

### TECHNICAL FIELD

The present invention relates to an image processing device, an image processing method, and a computer-readable recording medium in which an image processing program is recorded.

### BACKGROUND ART

As a method for accelerating inference on an image (e.g., inferring type of an object shown in an image), a following technique is known. Namely, a technique is known that improves processing efficiency of inference and accelerates it by simplifying processing for a predetermined portion of the image (e.g., a background portion). Hereinafter, this technique is referred to as acceleration technique P for convenience.

PTL 1 describes an inference device that performs predetermined inference processing on input image data using a machine learning model.

Furthermore, PTL 2 describes an information processing device that improves inference throughput.

### CITATION LIST

### Patent Literature

PTL 1: Japanese Patent Application Laid-Open No. 2021-144461
PTL 2: Japanese Patent Application Laid-Open No. 2022-142119

### SUMMARY OF INVENTION

### Technical Problem

In the acceleration technique P, processing efficiency varies depending on an image. When an area of the predetermined portion (here, for example, the predetermined portion is a background portion) in an image is large, amount of processing that can be simplified increases, and the processing efficiency improves. Conversely, when the area of the predetermined portion (the background portion) in the image is small, the amount of processing that can be simplified is small, and the degree of improvement in the processing efficiency is also small.

Therefore, when adopting the acceleration technique P, amount of computational resources used for inference on an image is not constant but fluctuates. For example, when applying the acceleration technique P to an inference means and allocating computational resources to the inference means, surplus computational resources, i.e., unused computational resources remaining from the allocated computational resources, may or may not occur. When the surplus computational resources which are the unused computational resources remaining from the allocated computational resources for inference processing occur, it is desirable to effectively utilize these surplus computational resources. Note that the computational resources refer, for example, to processing capacity of a processor. The computational resources may be the processing capacity of a CPU (Central Processing Unit), a GPU (Graphics Processing Unit), or a FPGA (Field-Programmable Gate Array). Alternatively, the computational resources may be the processing capacity of, for example, an ASIC (Application Specific Integrated Circuit).

Therefore, the purpose of the present invention is to provide an image processing device, an image processing method, and a computer-readable recording medium in which an image processing program is recorded that can effectively utilize surplus computational resources remaining unused from allocated computational resources for inference processing when such surplus computational resources occur.

### Solution to Problem

An image processing device according to the present invention includes inference means that performs predetermined inference on sequentially input images, and increases processing efficiency of inference by simplifying processing for a predetermined portion of images when performing the predetermined inference; ground truth data generation means that generates, for some of the input images, ground truth data including an image and a ground truth label that is a ground truth corresponding to the predetermined inference for the image; and computational resources allocation means that allocates unused computational resources to the inference means, and when surplus computational resources which are unused computational resources remaining from allocated computational resources occur in the inference means, allocates the surplus computational resources to the ground truth data generation means.

An image processing method according to the present invention is characterized in that computational resources allocation means allocates unused computational resources to inference means; the inference means performs predetermined inference on sequentially input images, and increases processing efficiency of inference by simplifying processing for a predetermined portion of images when performing the predetermined inference; when surplus computational resources which are unused computational resources remaining from allocated computational resources occur in the inference means, the computational resources allocation means allocates the surplus computational resources to ground truth data generation means; and the ground truth data generation means generates, for some of the input images, ground truth data including an image and a ground truth label that is a ground truth corresponding to the predetermined inference for the image.

A computer-readable recording medium according to the present invention is a computer-readable recording medium in which an image processing program is recorded, wherein the image processing program causes a computer to function as: inference means that performs predetermined inference on sequentially input images, and increases processing efficiency of inference by simplifying processing for a predetermined portion of images when performing the predetermined inference; ground truth data generation means that generates, for some of the input images, ground truth data including an image and a ground truth label that is a ground truth corresponding to the predetermined inference for the image; and computational resources allocation means that allocates unused computational resources to the inference means, and when surplus computational resources which are unused computational resources remaining from allocated computational resources occur in the inference means, allocates the surplus computational resources to the ground truth data generation means.

### Advantageous Effects of Invention

According to the present invention, when surplus computational resources which are unused computational resources remaining from allocated computational resources for inference processing occur, these surplus computational resources can be effectively utilized.

### BRIEF DESCRIPTION OF DRAWING

FIG. 1 It depicts a schematic diagram showing an image processing device of the example embodiment of the present invention and a learning device connected to the image processing device.

FIG. 2 It depicts a block diagram showing a configuration example of the image processing device of the example embodiment of the present invention.

FIG. 3 It depicts a schematic diagram showing an example of jobs to be placed in the job queue.

FIG. 4 It depicts a flowchart showing an example of a processing flow for inference processing by the image processing device.

FIG. 5 It depicts a flowchart showing an example of a processing flow for a ground truth data generation job.

FIG. 6 It depicts a flowchart showing an example of a generation process for an accuracy evaluation job.

FIG. 7 It depicts a flowchart showing an example of a processing flow for an accuracy evaluation job.

FIG. 8 It depicts a flowchart showing an example of a processing flow for a model update job.

FIG. 9 It depicts a flowchart showing an example of a processing flow for allocating surplus computational resources.

FIG. 10 It depicts a block diagram showing a modified example of the image processing device of the example embodiment of the present invention.

FIG. 11 It depicts a schematic block diagram showing an example of a computer configuration of the image processing device of the present invention.

FIG. 12 It depicts a block diagram showing an overview of the image processing device of the present invention.

### DESCRIPTION OF EMBODIMENTS

An example embodiment of the present invention is described below with reference to the drawings.

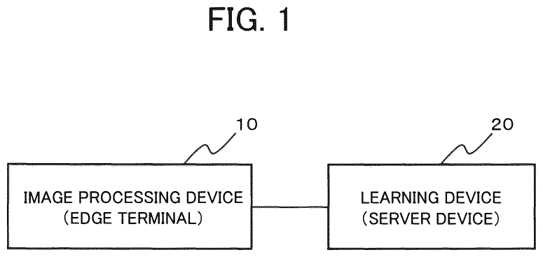

FIG. 1 is a schematic diagram showing an image processing device of the example embodiment of the present invention and a learning device connected to the image processing device. The image processing device 10 is connected to the learning device 20, for example, via a communication network. The image processing device 10 is realized, for example, by an edge terminal, and the learning device 20 is realized, for example, by a server device. The following description uses the example where the image processing device 10 is an edge terminal and the learning device 20 is a server device.

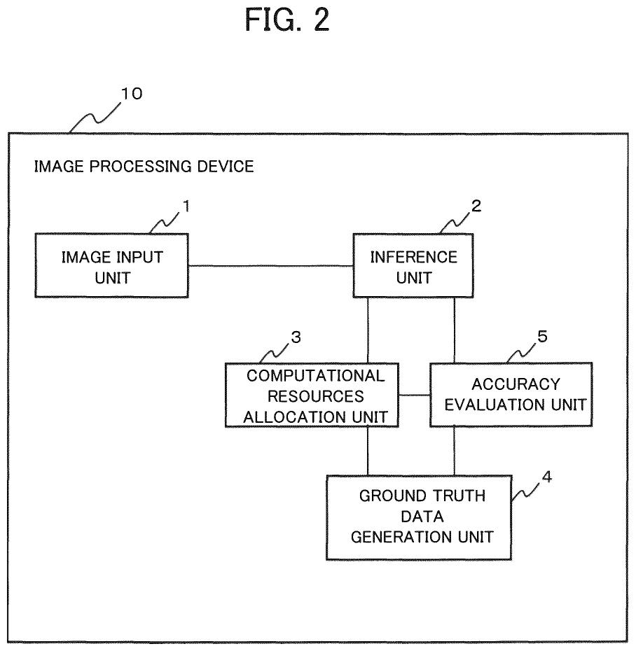

The image processing device 10 periodically generates an image by taking a photo with a camera, etc., and performs predetermined inference on each image. At this time, an inference unit 2 (see FIG. 2), described later, provided in the image processing device 10 performs the predetermined inference on each image using a model obtained through machine learning.

The following example illustrates performing image recognition (class classification) as the predetermined inference. However, the predetermined inference is not limited to this and may be other inference processing (tasks).

Upon receiving ground truth data described later from the image processing device 10, the learning device 20 adds this ground truth data to existing learning data, and then uses the learning data containing this ground truth data to generate a new model through machine learning.

The image processing device 10 obtains the new model from the learning device 20 and updates the model used by the inference unit 2 with this new model.

FIG. 2 is a block diagram showing a configuration example of the image processing device of the example embodiment of the present invention. The image processing device 10 comprises an image input unit 1, an inference unit 2, a computational resources allocation unit 3, a ground truth data generation unit 4, and an accuracy evaluation unit 5.

The image input unit 1 generates an image by capturing the vicinity of the image processing device 10 at a first fixed time interval (e.g., 100 ms interval) and sequentially inputs the generated images to the inference unit 2. The image input unit 1 may be realized, for example, by a camera. Alternatively, an image input interface, through which images are input from a camera located outside the image processing device 10, may also constitute the image input unit 1. The following example describes the case where the image input unit 1 is a camera. Note that there may be multiple image input units 1.

The inference unit 2 performs the predetermined inference on images input sequentially from the image input unit 1. Examples of the predetermined inference include inferring type of an object (e.g., a vehicle, a person, etc.) depicted in the image and inferring posture of an object depicted in the image. However, the predetermined inference is not limited to these examples. The inference unit 2 derives a class (e.g., in the above examples, a class for the object type or a class for the object's posture) as an inference result. The inference unit 2 may also derive a confidence score for the result in addition to the class as an inference result.

Furthermore, the inference unit 2 employs the acceleration technique P when performing the predetermined inference. Specifically, the inference unit 2 increases processing efficiency of the inference by simplifying processing for a predetermined portion of the images (e.g., the background portion) when performing the predetermined inference.

The inference unit 2 is allocated unused computational resources by the computational resources allocation unit 3, and the inference unit 2 constantly performs the predetermined inference on the images input at the first fixed time interval (e.g., 100 ms interval).

Since inference unit 2 employs the acceleration technique P, the surplus computational resources which are unused computational resources remaining from allocated computational resources may or may not occur depending on the input image. In the present example embodiment, surplus refers to the computational resources allocated by the computational resources allocation unit 3 to the inference unit 2 that remain unused by the inference unit 2. The surplus computational resources may include computational resources not allocated to any processing. As mentioned earlier, computational resources represent the processing capacity of a processor. The computational resources may be the processing capacity of a CPU, a GPU, or a FPGA. Alternatively, the computational resources may be the processing capacity of, for example, an ASIC.

Furthermore, the inference unit 2 performs the predetermined inference on the images using a model obtained through machine learning (e.g., deep learning). This model is a model for deriving inference results in the predetermined inference. This model may be a general-purpose model generated by machine learning using general learning data, rather than learning data specific to the peripheral environment of the edge terminal, which is the image processing device 10. Therefore, when an image with features different from those in the learning data is input to the inference unit 2, the inference result derived by the inference unit 2 may be incorrect.

The computational resources allocation unit 3 allocates unused computation resources to the inference unit 2 while securing computation resources for its own use. As a result, the inference unit 2 can perform the predetermined inference on the images input at the first fixed time interval (e.g., 100 ms interval) at all times.

When the surplus computational resources which are unused computational resources remaining from allocated computational resources occur in the inference unit 2, the computational resources allocation unit 3 allocates these surplus computational resources to the ground truth data generation unit 4 or the accuracy evaluation unit 5. The ground truth data generation unit 4 and the accuracy evaluation unit 5 can then execute their respective processes by being allocated computational resources. When allocating the surplus computational resources to the accuracy evaluation unit 5, the computational resources allocation unit 3 may also allocate the surplus computational resources to the inference unit 2.

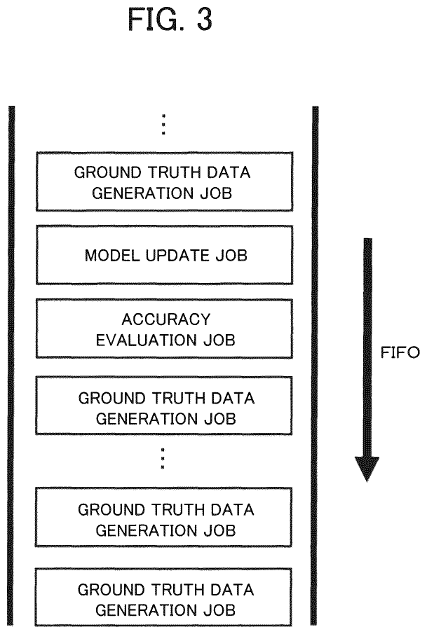

Furthermore, in the present example embodiment, the computational resources allocation unit 3 generates a job (hereinafter referred to as a ground truth data generation job) that samples input images at a second fixed time interval (e.g., 10-minute interval) and generates ground truth data for those images, then places the ground truth data generation job into the job queue. The job queue is a FIFO (First In First Out) job queue. FIG. 3 is a schematic diagram showing an example of jobs to be placed in the job queue. An accuracy evaluation job and a model update job shown in FIG. 3 will be described later.

The method by which the computational resources allocation unit 3 allocates the surplus computational resources to the ground truth data generation unit 4 or the accuracy evaluation unit 5 is arbitrary. For example, the computational resources allocation unit 3 may allocate the surplus computational resources to the ground truth data generation unit 4 or the accuracy evaluation unit 5 that executes the job at the front of the job queue.

The computational resources allocation unit 3 may allocate the computational resources using time division or space division. In the case of time division, the computational resources allocation unit 3 allows the computational resources to be used by the process to which they are allocated during a designated time interval. When a time interval (timeslot) ends, the execution of the process allocated that time interval is temporarily suspended, and the execution of the process allocated the next time interval begins. The execution of the suspended process resumes at the start of the next allocated time interval. In the case of space division, groups of computational resource elements constituting the computational resources are formed, and computational resource element groups are allocated to processes. The computational resources allocation unit 3 may use both time division and space division. The computational resources allocation unit 3 may also use methods other than time division and space division.

The ground truth data generation unit 4 generates ground truth data for the sampled image. This ground truth data includes the image and a ground truth label that is a ground truth corresponding to the predetermined inference for that image. The sampled images can be said to be some of a plurality of images input by the image input unit 1.

The ground truth data generation unit 4 executes the ground truth data generation job when the next job to be processed in the job queue is the ground truth data generation job and the computational resources have been allocated by the computational resources allocation unit 3. Specifically, the ground truth data generation unit 4 performs inference on the image (the sampled image) indicated by the ground truth data generation job, uses the inference result as the ground truth label, and generates ground truth data containing that image and the ground truth label. The ground truth data generation unit 4 obtains the inference result, for example, by applying the image to a model generated through machine learning such as deep learning using learning data specialized for the peripheral environment of the edge terminal, which is the image processing device 10. Therefore, the inference result obtained by the ground truth data generation unit 4 can be said to be the ground truth label. The scale of the model used by the ground truth data generation unit 4 may be large, and it is acceptable if deriving the ground truth label by the ground truth data generation unit 4 takes some time.

It should be noted that the model used by the ground truth data generation unit 4 need not be one trained using learning data specialized for the peripheral environment of the edge terminal; it may also be one trained using more general learning data. Furthermore, the method by which the ground truth data generation unit 4 generates the ground truth data is arbitrary, and methods other than those described above may also be used.

The ground truth data generation unit 4 stores the ground truth data, which includes images and ground truth labels, as a database.

The accuracy evaluation unit 5 generates, at a third fixed time interval (e.g., a one-day interval), a job (hereinafter referred to as an accuracy evaluation job) to evaluate the accuracy of the model used by the inference unit 2, and places the accuracy evaluation job into the job queue. The computational resources required to generate the accuracy evaluation job and place it in the job queue are negligible. These negligible computational resources are allocated to the accuracy evaluation unit 5 by the computational resources allocation unit 3.

The accuracy evaluation unit 5 evaluates the accuracy of the model used by the inference unit 2 using each ground truth data (i.e., executes the accuracy evaluation job) when the next job to be processed in the job queue is an accuracy evaluation job and the computational resources have been allocated by the computational resources allocation unit 3. Evaluating the accuracy of the model used by the inference unit 2 is, in other words, evaluating the accuracy of the inference results produced by the inference unit 2.

Specifically, the accuracy evaluation unit 5 evaluates the accuracy of the inference results produced by the inference unit 2 as follows. The accuracy evaluation unit 5 causes the inference unit 2 to perform the predetermined inference for each image included in each ground truth data. In this case, the inference unit 2 is allocated the surplus computational resources by the computational resources allocation unit 3 and performs the predetermined inference using those computational resources. The accuracy evaluation unit 5 then evaluates the accuracy of the inference results obtained by the inference unit 2 by comparing each inference result (class) obtained by the inference unit 2 with the corresponding ground truth label included in the respective ground truth data.

At this time, the accuracy evaluation unit 5 derives an accuracy evaluation value, which is an evaluation value of the accuracy of the inference results by the inference unit 2. The higher the accuracy, the larger the accuracy evaluation value; the lower the accuracy, the smaller the accuracy evaluation value. An example of the accuracy evaluation value is, for instance, a percentage of matches (a match rate) between the inference results (classes) obtained by the inference unit 2 and the ground truth labels. However, the accuracy evaluation value is not limited to such a match rate and may be an evaluation value obtained by other methods.

If the accuracy evaluation value is less than or equal to a predetermined threshold, the accuracy evaluation unit 5 generates a job (hereinafter referred to as a model update job) to update the model used by the inference unit 2 and places the model update job into the job queue.

The accuracy evaluation unit 5 executes the model update job when the next job to be processed in the job queue is the model update job and the computational resources have been allocated by the computational resources allocation unit 3.

Specifically, the accuracy evaluation unit 5 transmits the ground truth data stored as a database to the learning device 20 (see FIG. 1), thereby causing the learning device 20 to generate a new model using that ground truth data through machine learning such as deep learning. Upon receiving the ground truth data from the accuracy evaluation unit 5, the learning device 20 adds this ground truth data to its existing learning data, then uses this learning data, including the ground truth data, to generate the new model through machine learning. The learning device 20 transmits the new model to the accuracy evaluation unit 5 of the image processing device 10, and the accuracy evaluation unit 5 acquires the new model. The accuracy evaluation unit 5 then updates the model used by the inference unit 2 with the new model.

The learning device 20 may retain learning evaluation data consisting of ground truth data for evaluating the generated model and use it to evaluate the generated model. The learning device 20 may generate multiple models under different conditions or using different sets of ground truth data, and for example, may select the model with the highest evaluation result using the learning evaluation data as the final result. The learning device 20 may add a portion of the ground truth data received from the accuracy evaluation unit 5 to the existing learning data and add the remainder to the existing learning evaluation data.

The new model is generated using the learning data containing the ground truth data that is spatially and temporally close to the image processing device 10, pertaining to the images around the image processing device 10. Therefore, the accuracy of the new model can be said to be higher than that of the model before the update. Consequently, for example, if the accuracy of the model initially used by the inference unit 2 is low, that model can be updated to a higher-accuracy model. Furthermore, if the accuracy of the model used by the inference unit 2 decreases due to changes in the surrounding environment of the edge terminal, which is the image processing device 10, that model can be updated to a more accurate model.

The inference unit 2, the computational resources allocation unit 3, the ground truth data generation unit 4, and the accuracy evaluation unit 5 are realized, for example, by a CPU of a computer operating according to an image processing program. For example, the CPU may read the image processing program from a program recording medium such as the computer's program memory device and operate as the inference unit 2, the computational resources allocation unit 3, the ground truth data generation unit 4, and the accuracy evaluation unit 5 according to that image processing program. Alternatively, or in addition to the CPU, a GPU, a FPGA, an ASIC, etc., may be used.

Next, the processing flows are described. Details already explained are omitted as appropriate.

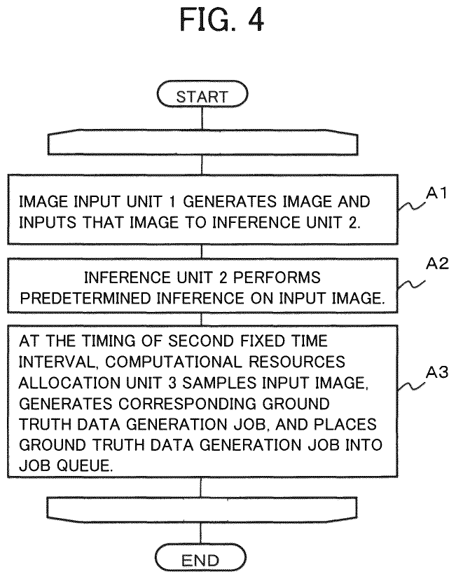

FIG. 4 is a flowchart showing an example of a processing flow for inference processing by the image processing device 10. The computational resources allocation unit 3 is assumed to allocate the unused computation resources to the inference unit 2. Steps A1 and A2 shown in FIG. 4 are repeatedly executed at the first fixed time interval (e.g., 100 ms interval). Note that the first fixed time interval is not limited to 100 ms interval.

In step A1, the image input unit 1 generates an image through capture and inputs that image to the inference unit 2.

In step A2, the inference unit 2 performs the predetermined inference on the image input in step A1. The inference unit 2 may derive the inference result by applying the image to the model (the model used by the inference unit 2). Furthermore, the inference unit 2 employs the acceleration technique P to derive the inference result.

Furthermore, at the timing of the second fixed time interval (e.g., 10-minute interval), the computational resources allocation unit 3 samples the input image, generates a corresponding ground truth data generation job, and places the ground truth data generation job into the job queue (step A3). Therefore, at the second fixed time interval, a ground truth data generation job is created and placed into the job queue. Note that the second fixed time interval is not limited to 10-minute interval.

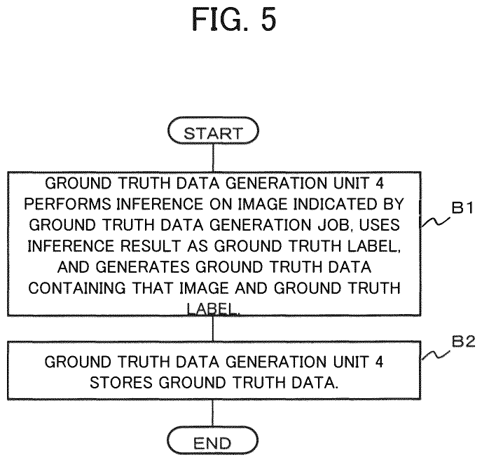

FIG. 5 is a flowchart showing an example of a processing flow for a ground truth data generation job. When executing a ground truth data generation job, the ground truth data generation unit 4 performs inference on the image indicated by the ground truth data generation job, uses the inference result as the ground truth label, and generates the ground truth data containing that image and the ground truth label (step B1). The ground truth data generation unit 4 performs the inference using the model generated by machine learning using learning data specialized for the peripheral environment of the edge terminal, which is the image processing device 10. Therefore, the inference result by the ground truth data generation unit 4 can be said to be the ground truth label.

The ground truth data generation unit 4 stores the ground truth data generated in step B1 (step B2). Then, the ground truth data generation job is terminated.

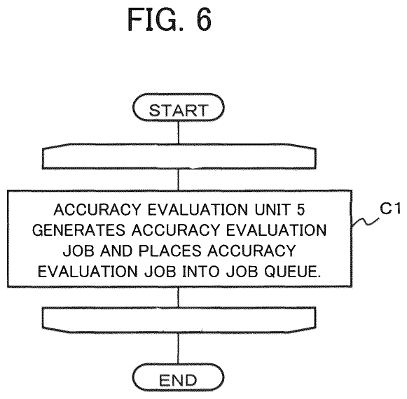

FIG. 6 is a flowchart showing an example of a generation process for an accuracy evaluation job. Step C1 shown in FIG. 6 is repeatedly executed at the third fixed time interval (e.g., a one-day interval). Note that the third fixed time interval is not limited to a one-day interval.

In step C1, the accuracy evaluation unit 5 generates an accuracy evaluation job and places the accuracy evaluation job into the job queue. The accuracy evaluation unit 5 performs this process at every third fixed time interval.

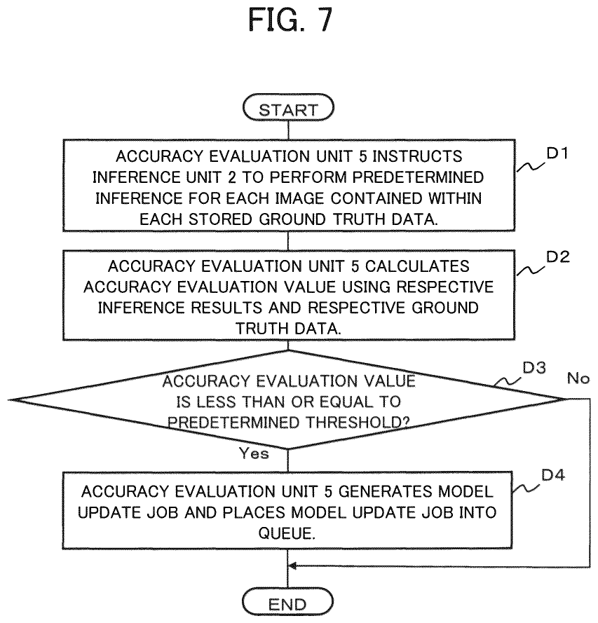

FIG. 7 is a flowchart showing an example of a processing flow for an accuracy evaluation job. When executing the accuracy evaluation job, the accuracy evaluation unit 5 instructs the inference unit 2 to perform the predetermined inference for each image contained within each ground truth data stored in the ground truth data generation unit 4 (step D1). At this time, the inference unit 2 is allocated the surplus computational resources from the computational resources allocation unit 3 and uses these computational resources to perform the predetermined inference.

Next, the accuracy evaluation unit 5 calculates the accuracy evaluation value using the respective inference results obtained in step D1 and the respective ground truth data (step D2).

Next, the accuracy evaluation unit 5 determines whether the accuracy evaluation value is less than or equal to a predetermined threshold (step D3).

If the accuracy evaluation value is greater than the predetermined threshold (step D3 No), the accuracy evaluation job is terminated.

If the accuracy evaluation value is less than or equal to the predetermined threshold (step D3 Yes), the accuracy evaluation unit 5 generates the model update job and places the model update job into the job queue (step D4). Then, the accuracy evaluation job is terminated.

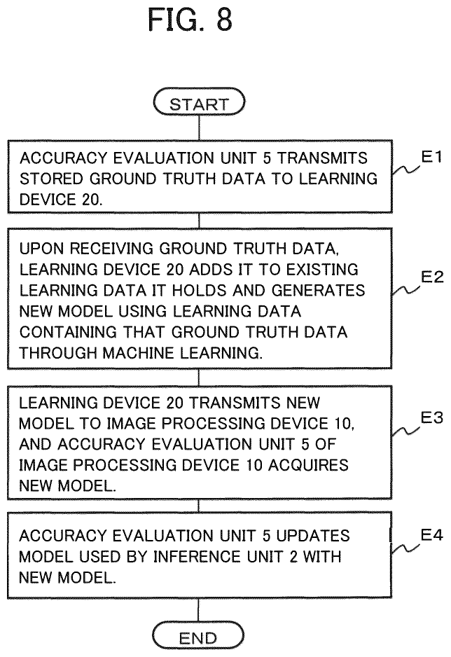

FIG. 8 is a flowchart showing an example of a processing flow for a model update job. When executing the model update job, the accuracy evaluation unit 5 transmits the ground truth data stored in the ground truth data generation unit 4 to the learning device 20 (see FIG. 1) (step E1).

Upon receiving the ground truth data, the learning device 20 adds it to the existing learning data it holds and generates a new model using the learning data containing that ground truth data through machine learning (step E2).

The learning device 20 transmits the new model to the image processing device 10, and the accuracy evaluation unit 5 of the image processing device 10 acquires the new model (step E3).

Next, the accuracy evaluation unit 5 updates the model used by the inference unit 2 with the new model (step E4). Then, the model update job is terminated.

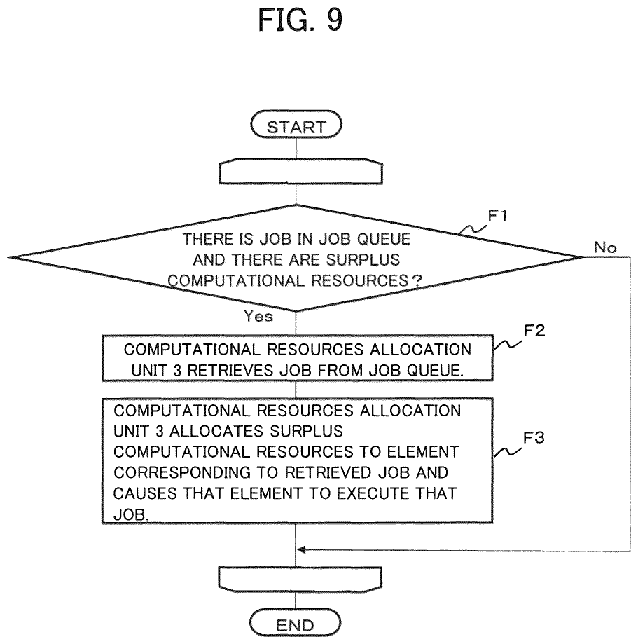

FIG. 9 is a flowchart showing an example of a processing flow for allocating surplus computational resources. The computational resources allocation unit 3 determines whether there is a job in the job queue and whether there are surplus computational resources (step F1).

If there are no jobs in the job queue or if there are no surplus computational resources (step F1 No), the process in step F1 is repeated.

If there is a job in the job queue and there are surplus computational resources (step F1 Yes), the computational resources allocation unit 3 retrieves one job from the job queue (step F2).

Then, the computational resources allocation unit 3 allocates the surplus computational resources to the element corresponding to the retrieved job and causes that element to execute that job (step F3).

For example, suppose the job retrieved in step F2 is a ground truth data generation job. In this case, the computational resources allocation unit 3 allocates the surplus computational resources to the ground truth data generation unit 4 and causes the ground truth data generation unit 4 to execute the ground truth data generation job (see FIG. 5).

Furthermore, for example, suppose the job retrieved in step F2 is an accuracy evaluation job. In this case, the computational resources allocation unit 3 allocates the surplus computational resources to the accuracy evaluation unit 5 and the inference unit 2, causes the accuracy evaluation unit 5 and the inference unit 2 to execute the accuracy evaluation job (see FIG. 7).

Furthermore, for example, suppose the job retrieved in step F2 is a model update job. In this case, the computational resources allocation unit 3 allocates the surplus computational resources to the accuracy evaluation unit 5 and causes the accuracy evaluation unit 5 to execute the model update job (see FIG. 8).

After step F3, the processing from step F1 onwards is repeated.

According to the present example embodiment, when surplus computational resources remain unused from computational resources allocated for inference processing while the inference unit 2 continuously performs the predetermined inference on input images at the first fixed time interval (e.g., 100 ms interval), the surplus computational resources can be effectively utilized.

For example, the computational resources allocation unit 3 can allocate the surplus computational resources to the ground truth data generation unit 4, and the ground truth data generation unit 4 can generate ground truth data used for evaluating the accuracy of inference results by the inference unit 2 or for model learning.

Furthermore, for example, the computational resources allocation unit 3 can allocate the surplus computational resources to the accuracy evaluation unit 5 and the inference unit 2, enabling the accuracy evaluation unit 5 to evaluate the accuracy of the inference results produced by the inference unit 2.

Furthermore, for example, the computational resources allocation unit 3 may allocate the surplus computation resources to the accuracy evaluation unit 5, and the accuracy evaluation unit 5 can update the model used by the inference unit 2 to a higher-accuracy model.

Next, various variations of the present example embodiment will be described.

In the above description, the inference unit 2 performed inference for each individual image generated by the image input unit 1 (see FIG. 4). However, the present example embodiment is not limited to this. As another example, the inference unit 2 may perform inference on multiple images generated by the image input unit 1 collectively. Processing multiple images together can significantly improve processing efficiency using the acceleration technique P, potentially increase more surplus computational resources. Furthermore, if there are multiple image input units 1, the inference unit 2 may perform inference on images from multiple image input units 1 together.

In the above description, the image processing device 10 performed image recognition as the predetermined inference. However, the present example embodiment is not limited to this. As another example, the image processing device 10 may perform object detection. When the image processing device 10 performs object detection, the inference unit 2 performs inference using a model for object detection. In that case, the inference unit 2 derives, for each detected object as an inference result, the class, confidence score, and positional information (e.g., the coordinates of the four vertices of a rectangle surrounding the object). Furthermore, the ground truth data generation unit 4 generates ground truth data for object detection, and the learning device 20 generates a model for object detection. The accuracy evaluation unit 5 evaluates accuracy using, for example, precision (the proportion of correct detections among detected objects), recall (the proportion of objects that should be detected but were detected), average precision (AP) or mean AP (mAP) (which averages multiple precisions derived under different conditions), or a combination thereof.

The above description illustrated an example where the inference unit 2 performs the predetermined inference on an image using a model obtained through machine learning. The inference unit 2 may perform inference by selectively using multiple models or by combining them. Furthermore, the inference unit 2 may utilize such multiple models in conjunction with the adoption of the acceleration technique P.

The above description illustrated an example where the inference unit 2 employs acceleration technique P. The inference unit 2 may selectively use or combine multiple acceleration techniques, such as first acceleration technique P1 and second acceleration technique P2. In such cases, the inference unit 2 may initially maintain and use only the model for the first acceleration technique P1 for inference, and the ground truth data generation unit 4 may then generate ground truth data using the surplus computational resources resulting from the use of the first acceleration technique P1. Furthermore, in such cases, the accuracy evaluation unit 5 may generate a model update job regardless of the accuracy evaluation value of the inference results from the inference unit 2. The accuracy evaluation unit 5 may, for example, generate a model update job when a predetermined amount of ground truth data has been generated. The new model generated by this model update job may be a model for the second acceleration technique P2. After the model for the second acceleration technique P2 is generated, the inference unit 2 may switch the adopted technique from the first acceleration technique P1 to the second acceleration technique P2.

The above description illustrated an example where the computational resources allocation unit 3 samples input images at the second fixed time interval. However, the present example embodiment is not limited to this. As another example, the computational resources allocation unit 3 may sample images using the following conditions:
(a) When the inference result's confidence score is greater than or equal (or less than or equal to) a predetermined threshold
(b) When the processing time for inference is greater than or equal (or less than or equal to) a predetermined threshold
(c) When the number of detected objects is greater than or equal (or less than or equal to) a predetermined threshold
(d) When the class of the detected object is a predetermined class (or not a predetermined class)
(e) When the confidence score of the detected object is greater than or equal to (or less than or equal to) a predetermined threshold
(f) When the detected object is included (or not included) within a predetermined area
(g) When the area of the detected object is greater than or equal to (or less than or equal to) a predetermined threshold
(h) When the area of the predetermined portion of the image processed by acceleration technique P is greater than or equal to (or less than or equal to) a predetermined threshold
(i) When the degree of improvement in processing efficiency by acceleration technique P is greater than or equal (or less than or equal to) a predetermined threshold

The computational resources allocation unit 3 may determine the image to be sampled using any one or a combination of the above examples. Furthermore, the computational resources allocation unit 3 may sample the image using conditions related to, the result of inference, information obtained when using acceleration technique P during inference, the amount of computation resources consumed during inference, and time.

The above description illustrated an example where the accuracy evaluation unit 5 generates an accuracy evaluation job at the third fixed time interval. However, the present example embodiment is not limited to this. As another example, the accuracy evaluation unit 5 may generate an accuracy evaluation job based on conditions similar to those used by the aforementioned computational resources allocation unit 3 to determine which images to sample. Furthermore, the accuracy evaluation unit 5 may also use conditions related to the amount of generated ground truth data.

The above description illustrated an example where the accuracy evaluation unit 5 generates a model update job when the accuracy evaluation value is less than or equal to a predetermined threshold. However, the present example embodiment is not limited to this. As another example, the accuracy evaluation unit 5 may generate a model update job based on conditions similar to those used by the aforementioned computational resources allocation unit 3 to determine which images to sample.

The above description illustrated an example where the accuracy evaluation unit 5 evaluates the accuracy of the model used by the inference unit 2 using ground truth data generated by the ground truth data generation unit 4. However, the present example embodiment is not limited to this. As another example, the accuracy evaluation unit 5 may pre-store evaluation data, which is ground truth data for evaluation purposes, and use the evaluation data to evaluate the accuracy of the model. Furthermore, the accuracy evaluation unit 5 may evaluate the accuracy of the model by combining the evaluation data with the ground truth data generated by the ground truth data generation unit 4, or by using parts thereof. The accuracy evaluation unit 5 may exclude the ground truth data used by the learning device 20 for model learning from the ground truth data used for evaluation.

The above description illustrated an example where the number of image processing devices 10 and the number of learning devices 20 are 1:1. However, the present example embodiment is not limited to this. As another example, the number of image processing devices 10 and the number of learning devices 20 may be in an n: m relationship. That is, an image processing device 10 may be connected to m learning devices 20, or a learning device 20 may be connected to n image processing devices 10.

When generating a new model, the learning device 20 may transmit that model to multiple image processing devices 10. The accuracy evaluation unit 5 of each image processing device 10 may receive that model and update the model used by the inference unit 2 with that new model.

When generating a new model for a particular image processing device 10, the learning device 20 may perform learning using ground truth data received from sources other than that image processing device 10.

The learning device 20 may maintain or update evaluation data for learning for each image processing device 10.

Next, a modified example of the image processing device of the example embodiment of the present invention will be described.

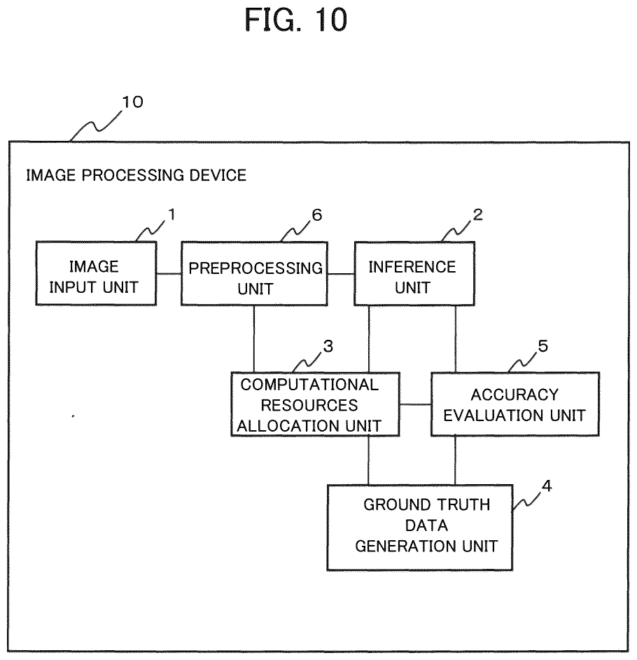

FIG. 10 is a block diagram showing a modified example of the image processing device of the example embodiment of the present invention. Elements common to the image processing device 10 of the aforementioned example embodiment (see FIG. 2) are designated by the same reference signs as in FIG. 2, and their descriptions are omitted. The image processing device 10 shown in FIG. 10 includes a preprocessing unit 6 in addition to the elements shown in FIG. 2. The preprocessing unit 6 performs preprocessing on the image input from the image input unit 1 and inputs the preprocessed image to the inference unit 2.

In the present modified example, the computational resources allocation unit 3 specifies the preprocessing to be performed by the preprocessing unit 6. The computational resources allocation unit 3 allocates the computation resources necessary to perform the specified preprocessing to the preprocessing unit 6. Examples of preprocessing types include sharpening and gamma correction and the like, but the preprocessing performed by the preprocessing unit 6 is not limited to these examples. Furthermore, the preprocessing type “do nothing” is also included.

In the present modified example, the computational resources allocation unit 3 generates a job (a preprocessing selection job) at a fourth fixed time interval (e.g., 1 hour interval) to select the preprocessing to be performed by the preprocessing unit 6, and places the preprocessing selection job into the job queue.

The accuracy evaluation unit 5 selects the preprocessing that the preprocessing unit 6 should perform when the next job to be processed in the job queue is the preprocessing selection job and the computational resources have been allocated by the computational resources allocation unit 3.

Specifically, the accuracy evaluation unit 5 causes the preprocessing unit 6 and the inference unit 2 to perform preprocessing and the predetermined inference for each image included in each ground truth data. In this case, the preprocessing unit 6 and the inference unit 2 are allocated the surplus computational resources by the computational resources allocation unit 3 and perform the predetermined inference using those computational resources.

The accuracy evaluation unit 5 may then evaluate the accuracy of the inference results from the inference unit 2 for each type of preprocessing and calculate an accuracy evaluation value. Furthermore, if a preprocessing is found where the accuracy evaluation value is greater than or equal to a predetermined second threshold, the computational resources allocation unit 3 selects that preprocessing. Note that the second threshold mentioned above is different from the threshold used in step D3 (see FIG. 7) and is a threshold with a larger value than the threshold used in step D3.

Alternatively, the accuracy evaluation unit 5 performs the predetermined inference for each preprocessing type and evaluates the accuracy of the inference results obtained by the inference unit 2. The computational resources allocation unit 3 may, for example, select the preprocessing that yielded the most accurate results. The computational resources allocation unit 3 may select “do nothing” as the preprocessing when the surplus computation resources are less than or equal to a predetermined threshold. When multiple acceleration techniques exist, the predetermined inference and the accuracy evaluation may be performed for each acceleration technique.

The computational resources allocation unit 3 sets the selected preprocessing as the preprocessing to be performed by the preprocessing unit 6. The computational resources allocation unit 3 may use only a portion of the ground truth data held by the ground truth data generation unit 4 during execution of the preprocessing selection job. For example, the computational resources allocation unit 3 may use ground truth data sampled during the same time period as the preprocessing selection job execution.

The above description illustrated an example where the computational resources allocation unit 3 generates a preprocessing selection job at the fourth fixed time interval. However, this embodiment is not limited this. As another example, the computational resources allocation unit 3 may generate a preprocessing selection job based on conditions similar to those used by the aforementioned computational resources allocation unit 3 to determine which images to sample.

Furthermore, the above example embodiment described a case where the learning device 20 generates a new model. The image processing device 10 may also be provided with a learning unit that adds ground truth data to existing learning data and generates a new model through machine learning using the learning data with the added ground truth data. That is, the image processing device 10 may generate a new model.

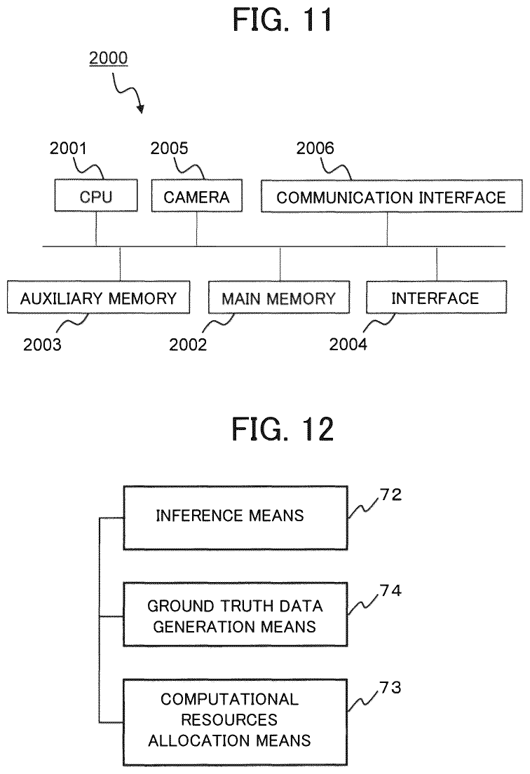

FIG. 11 is a schematic block diagram showing an example of a computer configuration of the image processing device of the present invention. The computer 2000 includes a CPU 2001, a main memory 2002, an auxiliary memory 2003, an interface 2004, a camera 2005, and a communication interface 2006. The communication interface 2006 interfaces with a communication network.

The image processing device 10 of the example embodiment and the modified example of the present invention is realized, for example, by the computer 2000. The operation of the image processing device 10 is stored in the auxiliary memory 2003 in the form of a program (an image processing program). The CPU 2001 reads the program from the auxiliary memory 2003, expands the program into the main memory 2002, and executes the processes described in the above example embodiment and the modified example according to the program.

The auxiliary memory 2003 is an example of a non-transitory tangible medium. Other examples of non-transitory tangible media include magnetic disks, magneto-optical disks, CD-ROM (Compact Disk Read Only Memory), DVD-ROM (Digital Versatile Disk Read Only Memory), semiconductor memory, etc., connected via the interface 2004.

Next, an overview of the present invention is described. FIG. 12 is a block diagram showing an overview of the image processing device of the present invention. The image processing device of the present invention includes an inference means 72, a ground truth data generation means 74, and a computational resources allocation means 73.

The inference means 72 (e.g., the inference unit 2) performs predetermined inference on sequentially input images, and increases processing efficiency of inference by simplifying processing for a predetermined portion of images when performing the predetermined inference.

The ground truth data generation means 74 (e.g., the ground truth data generation unit 4) generates, for some of the input images, ground truth data including an image and a ground truth label that is a ground truth corresponding to the predetermined inference for the image.

The computational resources allocation means 73 (e.g., the computational resources allocation unit 3) allocates unused computational resources to the inference means 72, and when surplus computational resources which are unused computational resources remaining from allocated computational resources occur in the inference means 72, allocates the surplus computational resources to the ground truth data generation means 74.

According to such a configuration, when surplus computational resources which are unused computational resources remaining from allocated computational resources for inference processing occur, these surplus computational resources can be effectively utilized.

An accuracy evaluation means (e.g., the accuracy evaluation unit 5) that evaluates accuracy of inference result by the inference means 72 using the ground truth data may be included, and when the surplus computational resources which are unused computational resources remaining from the allocated computational resources occur in the inference means 72, the computational resources allocation means 73 may allocate the surplus computational resources to the accuracy evaluation means.

The accuracy evaluation means may cause the inference means 72 to perform the predetermined inference for the image included in the ground truth data, and evaluate the accuracy of the inference result by the inference means 72, by comparing the inference result by the inference means 72 with the ground truth label included in the ground truth data.

The inference means 72 performs the predetermined inference on the images using a model obtained through machine learning, and if an accuracy evaluation value is less than or equal to a predetermined threshold, the accuracy evaluation means transmits the ground truth data to a learning means (e.g., the learning device 20) that learns the model, thereby causing the learning means to generate a new model using the ground truth data, obtains the new model from the learning means, and updates the model used by the inference means 72 with the new model.

While the present invention has been particularly shown and described with reference to example embodiment thereof, the present invention is not limited to this example embodiment. It will be understood by those of ordinary skill in the art that various changes in from and details may be made therein without departing from the spirit and scope of the present invention as defined by the claims.

### INDUSTRIAL APPLICABILITY

The present invention is suitably applied to an image processing device that performs predetermined inference on sequentially input images.

### REFERENCE SIGNS LIST

1 Image input unit
2 Inference unit
3 Computational resources allocation unit
4 Ground truth data generation unit
5 Accuracy evaluation unit
6 Preprocessing unit
10 Image processing device

What is claimed is:

1. An image processing device comprising:
a memory configured to store instructions; and
a processor configured to execute the instructions to:
execute an inference process of performing predetermined inference on sequentially input images, and increasing processing efficiency of inference by simplifying processing for a predetermined portion of images when performing the predetermined inference;
execute a ground truth data generation process of generating, for some of the input images, ground truth data including an image and a ground truth label that is a ground truth corresponding to the predetermined inference for the image; and
execute a computational resources allocation process of allocating unused computational resources to the inference process, and when surplus computational resources which are unused computational resources remaining from allocated computational resources occur in the inference process, allocating the surplus computational resources to the ground truth data generation process.

2. The image processing device according to claim 1,
wherein the processor
executes an accuracy evaluation process of evaluating accuracy of inference result by the inference process using the ground truth data,
wherein
when the surplus computational resources which are unused computational resources remaining from the allocated computational resources occur in the inference process, the processor allocates the surplus computational resources to the accuracy evaluation process.

3. The image processing device according to claim 2,
wherein in the accuracy evaluation process,
the processor performs the predetermined inference for the image included in the ground truth data, and evaluates the accuracy of the inference result by the inference process, by comparing the inference result by the inference process with the ground truth label included in the ground truth data.

4. The image processing device according to claim 2,
wherein
in the inference process, the processor performs the predetermined inference on the images using a model obtained through machine learning, and
if an accuracy evaluation value is less than or equal to a predetermined threshold, in the accuracy evaluation process, the processor transmits the ground truth data to a learning device that learns the model, thereby causing the learning device to generate a new model using the ground truth data, obtains the new model from the learning device, and updates the model used in the inference process with the new model.

5. An image processing method wherein,
a processor allocates unused computational resources to an inference process;
in the inference process, the processor performs predetermined inference on sequentially input images, and increases processing efficiency of inference by simplifying processing for a predetermined portion of images when performing the predetermined inference;
when surplus computational resources which are unused computational resources remaining from allocated computational resources occur in the inference process, the processor allocates the surplus computational resources to a ground truth data generation process; and
in the ground truth data generation process, the processor generates, for some of the input images, ground truth data including an image and a ground truth label that is a ground truth corresponding to the predetermined inference for the image.

6. The image processing method according to claim 5,
wherein when the surplus computational resources which are unused computational resources remaining from the allocated computational resources occur in the inference process, the processor allocates the surplus computational resources to an accuracy evaluation process; and
in the accuracy evaluation process, the processor evaluates accuracy of inference result by the inference process using the ground truth data.

7. A non-transitory computer-readable recording medium in which an image processing program is recorded, wherein the image processing program causes a computer to execute;
an inference process of performing predetermined inference on sequentially input images, and increasing processing efficiency of inference by simplifying processing for a predetermined portion of images when performing the predetermined inference;
a ground truth data generation process of generating, for some of the input images, ground truth data including an image and a ground truth label that is a ground truth corresponding to the predetermined inference for the image; and
a computational resources allocation process of allocating unused computational resources to the inference process, and when surplus computational resources which are unused computational resources remaining from allocated computational resources occur in the inference process, allocating the surplus computational resources to the ground truth data generation process.

8. The image processing device according to claim 1,
wherein the predetermined inference includes detecting an object of a predefined class, and information identifying the detected object to be provided to a user to support the user's decision making regarding a situation depicted in an input image.

9. The image processing method according to claim 5,
wherein the predetermined inference includes detecting an object of a predefined class, and information identifying the detected object to be provided to a user to support the user's decision making regarding a situation depicted in an input image.

10. The non-transitory computer-readable recording medium in which the image processing program is recorded according to claim 7,
wherein the predetermined inference includes detecting an object of a predefined class, and information identifying the detected object to be provided to a user to support the user's decision making regarding a situation depicted in an input image.
